(19) United States
(12) Patent Application Publication
(10) Pub. No.: US 2016/0217411 A1
(43) Pub. Date: Jul. 28, 2016

(54) TASK MANAGEMENT TECHNIQUES

(71) Applicant: NCR Corporation, Duluth, GA (US)

(72) Inventor: Matthew Kamp, Cumming, GA (US)

(21) Appl. No.: 14/606,131

(22) Filed: Jan. 27, 2015

(51) Int. Cl. G06Q 10/06; H04W 4/02

(52) U.S. Cl. CPC G06Q 10/063114; H04W 4/02

(57) ABSTRACT

Task management techniques which use a beacon to detect mobile communication devices carried by task performers. An example task management method includes receiving by a task management system a message containing a beacon identifier from a mobile communication device carried by a task performer within communication range of a beacon, determining by the task management system a location of the beacon from the beacon identifier, determining by the task management system a task scheduled to be performed at the location, and marking the task as completed by the task management system.

### BACKGROUND

The present invention relates to performance tracking and monitoring and more specifically to task management techniques.

Ensuring that tasks are performed may be difficult when the person performing the task is not actually being observed.

It would be desirable to provide task management techniques that direct, monitor, and/or track people assigned to perform tasks.

### SUMMARY

In accordance with the teachings of the present invention, task management techniques are provided.

Using these techniques, tasks can be prescheduled or dynamically assigned and electronically tracked.

An example task management method includes receiving by a task management system a message containing a beacon identifier from a mobile communication device carried by a task performer within communication range of a beacon, determining by the task management system a location of the beacon from the beacon identifier, determining by the task management system a task scheduled to be performed a the location, and marking the task as completed by the task management system.

In an example embodiment, the message also contains a task performer identifier.

In an example embodiment, the task management method further includes logging a time of receipt of the message by the task management system

In an example embodiment, the task management method further includes logging a task completion time by the task management system.

In an example embodiment, the task management method further includes receiving completion information entered by the task performer before marking the task as completed.

In an example embodiment, the task management method further includes sending a task completion acknowledgment message by the task management system to the mobile communication device.

In an example embodiment, the task management method further includes sending a next task message to the mobile communication device containing next scheduled task information by the task management system.

The mobile communication device may be equipped with a mobile application. The mobile application sends the message to the task management system.

An example beacon includes a Bluetooth Low Energy (BLE) standard beacon. An task management system employs beacons at locations where tasks are to be performed.

An example task method includes receiving a signal containing a beacon identifier from a beacon at a location where a task is to be performed by a mobile communication device carried by a task performer, and sending a message to a task management system containing the beacon identifier by the mobile communication device.

In an example embodiment, the message also contains a task performer identifier.

In an example embodiment, a mobile application of the mobile communication device sends the message to the task management system.

In an example embodiment, the method further includes recording entry of task completion information by the task performer into the mobile communication device, and sending the task completion information to the task management system by the mobile communication device.

In an example embodiment, the method further includes receiving an acknowledgment message from the task management system by the mobile communication device.

In an example embodiment, the method further includes receiving a next task message containing a next task to be performed from the task management system by the mobile communication device.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 is a block diagram of a task system;

FIG. 2 is a flow diagram illustrating an example task method; and

FIG. 3 is a flow diagram illustrating another example task method.

### DETAILED DESCRIPTION

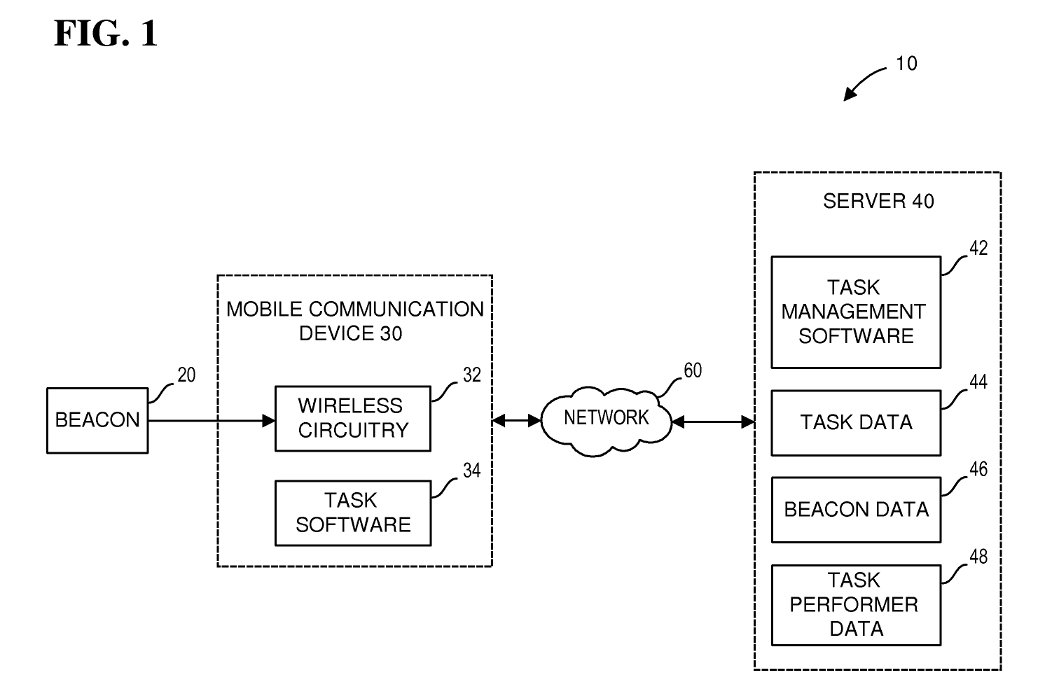

With reference to FIG. 1, an example performance management system 10 includes a beacon 20 at a site where a task is to be performed. More specifically, beacon 10 facilitates communication between a mobile communication device 30 carried by a task performer and a server 40.

Beacon 20 may include a Bluetooth Low Energy (BLE) standard beacon. Beacon 20 transmits a wireless signal, which may include a 2.4 GHz signal. Other types of wireless beacons and wireless devices are also envisioned.

When tasks must be performed at a plurality of different locations, a beacon 20 may be positioned at each location. For such purposes, each beacon 20 produces a signal with a unique identifier.

Mobile communication device 30 may include a smart phone, personal digital assistant, or other portable communication device. Mobile communication device 30 may include one or more processors, memory, program storage, a display, an input device (which may be combined with the display as a touch screen, and cellular and network communication circuitry. Mobile communication device 30 may execute an operating system such as a Microsoft, Google, or Apple operating system. The processor may execute software which is stored in a computer readable medium, such as a memory.

Mobile communication device 30 also includes wireless circuitry 32 and executes task software 34. Wireless circuitry 32 receives signals from beacon 20 when mobile communication device 30 is within communication range of beacon 20. In an example embodiment in which beacon 20 includes BLE circuitry, wireless circuitry 32 is also BLE circuitry.

Task software 34 may include a native mobile application. The customer causes mobile communication device 30 to download and install task software 34.

Task software 34 sends a message to server 40 when mobile communication device 30 is within communication range of beacon 20. Task software 34 determines whether wireless circuitry 32 is receiving signals from beacon 20. When wireless circuitry 32 is receiving signals from beacon 20, task software 34 sends a message to server 40 over network 60 containing the identifier of beacon 20.

Task software 34 may send additional information in the same or additional messages. For example, task software 34 may send a task performer identifier for distinguishing a plurality of task performers in task performer data 48.

As another example, task software 34, may send a mobile communication device identifier, such as a phone number.

As another example, task software 34 may send a task completion message indicating the task is complete and task completion information entered by the task performer using task software 34.

Task software 34 may receive an acknowledgment message from server 40.

Task software 34 may receive and display a list of tasks and corresponding task locations from server 40 in advance, or receive a next location and task from server 40.

In one example embodiment, task software 34 may both send and receive messages. In another example embodiment, task software 34 may only detect beacon 20 and send an initial message to server 40. Further communication between mobile communication device 30 and server 40 may then be carried out as a simple message service (text) message addressed to the phone number of mobile communication device 30, as an email message addressed to an email address of the task performer, or using other communication features that are built-in to mobile communication device 30.

Server 40 includes one or more processors, memory, and program storage, and may execute an operating system such as a Microsoft or Linux operating system. Server 40 further includes network circuitry for connecting to network 60, and may include other circuitry for connecting to peripherals.

The processor executes software which is stored in a computer readable medium, such as a memory. For example, server 40 may execute web server software and be connected to the World Wide Web (WWW or “web”) and provide web content, including web pages. The functions of server 40 may be provided by one or more computers “in the cloud”. Server 40 may be located where a task or tasks are being performed or elsewhere.

Server 40 executes task management software 42 which maintains task data 44 containing the details of the each task to be performed and the person assigned to perform each task, including task locations. Server 40 may further maintain information about beacons 20 in beacon data 46, including beacon locations and beacon identifiers, and information about task performers in task performer data 48, including a task performer identifier and phone number or email address that may be used to send the task performer reply messages, including text or email messages, or call or send an additional message to the task performer.

Task management software 42 may receive a message from mobile communication device 30 when mobile communication device 30 is within communication range of beacon 20 containing the identifier of beacon 20. Task management software 42 may then use the identifier to obtain the location of the task performer from beacon data 46 and update the status of the task in task data 44.

In addition to a beacon identifier, task management software 42 may receive other information in the same or additional messages from mobile communication device 30.

In one example embodiment, task management software 42 may receive a task performer identifier, such as a name or alias, from mobile communication device 30. Task management software 42 may verify that the person assigned to perform a task at a particular location is actually the one performing the task.

In another example embodiment, task management software 42 may receive a mobile communication device identifier, which can also be used by task management software 42 to verify that the person assigned to perform a task at a particular location is actually the one performing the task.

In another example embodiment, task management software 42 may receive task completion information entered by the person performing the task, which can also be used by task management software 42 to verify that the person assigned to perform a task at a particular location is actually the one performing the task.

In another example embodiment, task management software 42 may additionally determine and store an arrival time of the message.

Task management software 42 may send a list of tasks and corresponding task locations in advance to mobile communication device 30, or send a next location and task.

Task management software 42 may additionally track performance of all scheduled tasks against a predetermined schedule in task data 44.

Network 60 may include any combination of wireless or wired networks, including local area, wide area, virtual private, cellular, and global communication networks, such as the Internet.

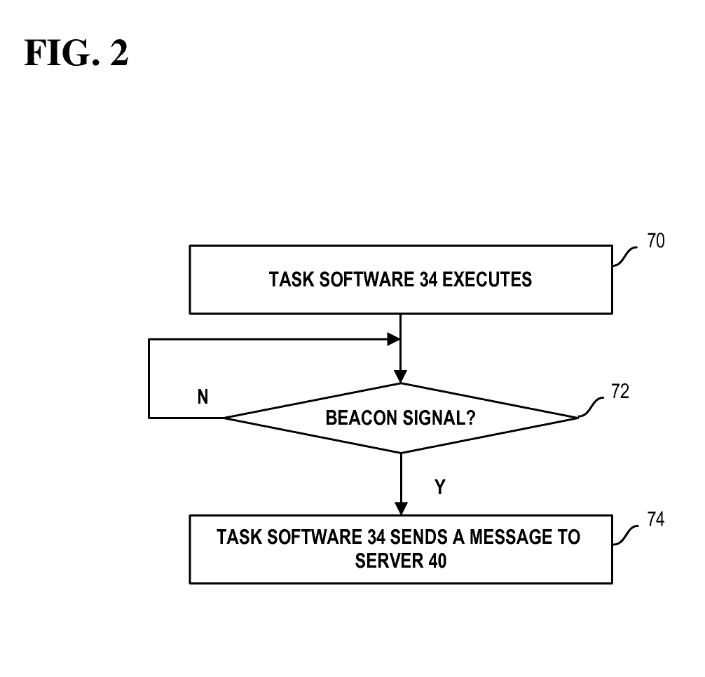

With reference to FIG. 2, operation of task software 34 is illustrated in more detail.

In step 70, task software 34 executes.

Task software 34 may operate in the background, such as when mobile device 30 is in “sleep” mode, ready to receive prompts from beacon 20.

In step 72, task software 34 determines that wireless circuitry 32 has received a signal from beacon 20.

In step 74, task software 34 sends a message to server 40 over network 60 containing a beacon identifier.

Task management software 42 receives the message and uses the beacon identifier to determine the location of the task performer in beacon data 44.

Task software 34 may send additional information in the same or additional messages, such as a task performer identifier. Task management software 42 may then verify that the person assigned to perform a task at a particular location is actually the one performing the task.

Task software 34 may send a mobile communication device identifier, which can also be used by task management software 42 to verify that the person assigned to perform a task at a particular location is actually the one performing the task.

Task software 34 may send task completion information entered by the person performing the task, which can also be used by task management software 42 to verify that the person assigned to perform a task at a particular location is actually the one performing the task.

Task software 34 may receive an acknowledgment message from server 40.

Task software 34 may receive a list of tasks and corresponding task locations from server 40 in advance, or receive a next location and task from server 40.

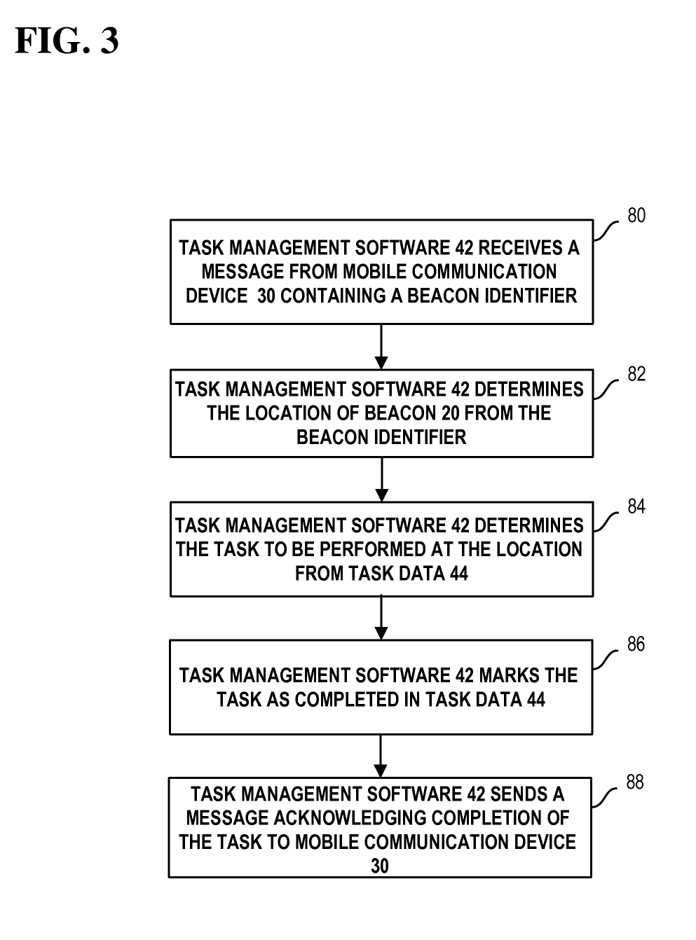

With reference to FIG. 3, operation of task management software 42 is illustrated in more detail.

In step 80, task management software 42 receives a message from mobile communication device 30 containing a beacon identifier, indicative of mobile communication device 30 being in communication range of beacon 20.

In an example embodiment, the message may also contain a task performer identifier.

Task management software 42 may log the time of receipt of the message in task data 44.

In step 82, task management software 42 determines the location of beacon 20 from beacon data 46.

In step 84, task management software 42 determines the task or tasks to be performed in task data 44 using the location information.

In step 86, task management software 42 marks the task as completed.

Task management software 42 may receive completion information entered by the person performing the task before marking the task as completed.

Task management software 42 may log a completion time in task data 44.

In step 88, task management software 42 may send a task completion acknowledgment message acknowledging completion of the task to mobile communication device 30. Task management software 42 may additionally send a next task message containing next scheduled task information.

Advantageously, in a sequence of scheduled tasks, task management software 42 may provide a report containing metrics, such as an average time to complete scheduled tasks, whether scheduled tasks required more or less time to complete than expected, and whether scheduled tasks which were started before, after or according to schedule. Task management software 42 may correlate these results with task performer identifiers to provide a statistical measure of when and where a person is located and what they are doing at a given time. These reports may be used to drive necessary behavior of people assigned as task performers.

For example, security management system 10 may be used to track the actions of a security guard responsible for checking that doors are locked and areas are secure. Security management system 10 may push tasks to the security guard via mobile communication device 30 and track the location and corresponding times of the security guard through beacons 20 located at each task location. For example, security management system 10 may send random locations at random times to ensure each area is being covered in a secure manner.

As another example, security management system 10 may be used to track the actions of a person responsible for cleaning one or more restrooms at given times and locations, such as in restaurants, retail stores, hotels, and fuel filling stations. Security management system 10 tracks the location and corresponding times of the person through beacons 20 located at each restroom.

As another example, security management system 10 may be used to track the actions of a person responsible for cleaning aisles, such as in a retail store or other commercial establishment. Security management system 10 tracks the location and corresponding times of the person through beacons 20 located at each aisle.

Other examples are also envisioned, including but not limited to, tracking the actions of a person responsible for stocking shelves, checking gas pumps, checking tills, and performing tasks related to airport security.

Advantageously, tasks can be prescheduled or dynamically assigned and electronically tracked.

Although the invention has been described with particular reference to certain preferred embodiments thereof, variations and modifications of the present invention can be effected within the spirit and scope of the following claims.

What is claimed is:

1. A task management method comprising:
receiving by a task management system a message containing a beacon identifier from a mobile communication device carried by a task performer within communication range of a beacon;
determining by the task management system a location of the beacon from the beacon identifier;
determining by the task management system a task scheduled to be performed a the location; and
marking the task as completed by the task management system.

2. The method of claim 1, wherein the message also contains a task performer identifier.

3. The method of claim 1, further comprising logging a time of receipt of the message by the task management system

4. The method of claim 1, further comprising logging a task completion time by the task management system.

5. The method of claim 1, further comprising receiving completion information entered by the task performer before marking the task as completed.

6. The method of claim 5, further comprising sending a task completion acknowledgment message by the task management system to the mobile communication device.

7. The method of claim 1, further comprising sending a next task message to the mobile communication device containing next scheduled task information by the task management system.

8. A task management method comprising:
establishing beacons having unique beacon identifiers at locations where tasks are to be performed;
receiving by a task management system a message containing one of the beacon identifiers and a task performer identifier from a mobile communication device carried by a task performer within communication range of a corresponding beacon;
logging a time of receipt of the message by the task management system;
determining by the task management system a location of the corresponding beacon from the one beacon identifier;
determining by the task management system the task to be performed a the location;
receiving a task completion message from the mobile communication device by the task management system;
marking the task as completed by the task management system;
logging a task completion time by the task management system; and
sending a task completion acknowledgment message by the task management system to the mobile communication device.

9. The method of claim 8, further comprising sending by the task management system a next task message to the mobile communication device containing a next task to be performed.

10. A task method comprising:
receiving a signal containing a beacon identifier from a beacon at a location where a task is to be performed by a mobile communication device carried by a task performer; and
sending a message to a task management system containing the beacon identifier by the mobile communication device.

11. The method of claim 10, wherein the message also contains a task performer identifier.

12. The method of claim 10, wherein a mobile application of the mobile communication device sends the message to the task management system.

13. The method of claim 10, further comprising:
recording entry of task completion information by the task performer into the mobile communication device; and
sending the task completion information to the task management system by the mobile communication device.

14. The method of claim 13, further comprising receiving an acknowledgment message from the task management system by the mobile communication device.

15. The method of claim 18, further comprising receiving a next task message containing a next task to be performed from the task management system by the mobile communication device.

16. A task system comprising:
a beacon at a location where a task is to be performed for producing a signal containing a beacon identifier; and
a task management system configured to
receive a message containing the beacon identifier from a mobile communication device carried by a task performer within communication range of the beacon;
determining by the task management system a location of the beacon from the beacon identifier;
determining by the task management system a task scheduled to be performed a the location; and
marking the task as completed by the task management system.

17. The system of claim 16, wherein the task management system is further configured to receive completion information entered by the task performer before marking the task as completed.

18. The system of claim 17, wherein the task management system is further configured to
send a task completion acknowledgment message to the mobile communication device.
